(19) United States
(12) Patent Application Publication
(10) Pub. No.: US 2017/0250773 A1
(43) Pub. Date: Aug. 31, 2017

(54) LIGHT SIGNAL MULTIPLEXER AND LIGHT SIGNAL DEMULTIPLEXER

(71) Applicant: ELECTRONICS AND TECNOLOGY RESEARCH INSTITUTE, Daejeon (KR)

(72) Inventors: Joon Young HUH, Daejeon (KR); Sae Kyoung KANG, Daejeon (KR); Jun Ki LEE, Daejeon (KR); Jie Hyun LEE, Daejeon (KR)

(21) Appl. No.: 15/440,075

(22) Filed: Feb. 23, 2017

(30) Foreign Application Priority Data
Feb. 26, 2016 (KR) 10-2016-0023592

(51) Int. Cl. H04J 14/02; G02B 27/14; G02B 27/10

(52) U.S. Cl. CPC H04J 14/02; G02B 27/1006; G02B 27/14; G02B 6/29386

(57) ABSTRACT

A light signal multiplexer and a light signal demultiplexer corresponding to the light signal multiplexer. The light signal multiplexer may include a reflector and a filter, in which the reflector is disposed on a plurality of input light paths to allow a plurality of light signals input along the input light paths to be reflected toward the filter disposed on at least one output light path, and the filter is disposed to allow the light signals reflected toward the filter to be reflected along the at least one output light path, and thus the light signal multiplexer may individually set the input light paths for the light signals.

### CROSS-REFERENCE TO RELATED APPLICATION(S)

This application claims the priority benefit of Korean Patent Application No. 10-2016-0023592 filed on Feb. 26, 2016, in the Korean Intellectual Property Office, the disclosure of which is incorporated herein by reference for all purposes.

### BACKGROUND

1. Field

One or more example embodiments relate to an optical communication device, and more particularly, to a device for multiplexing a plurality of light signals or demultiplexing the multiplexed light signals.

2. Description of Related Art

An optical communication device may generate a light signal based on an electrical signal, or generate an electrical signal based on a received light signal. Due to a rapid increase in traffic, an optical communication device having a higher transmission capacity is being developed.

A representative method of increasing a transmission capacity of an optical communication device may include a wavelength-division multiplexing (WDM) method. The WDM method may multiplex a plurality of light signals having different wavelengths onto a single optical fiber, and transmit the multiplexed light signals. The WDM method may be widely applied to a short-distance optical transport network (OTN), such as, for example, Ethernet, in addition to a medium- and long-distance OTN.

A light signal multiplexer may multiplex a plurality of light signals having different wavelengths onto a single optical fiber. The light signal multiplexer may multiplex the light signals using, for example, a method using an arrayed waveguide grating (AWG) and a bulk optics method using a thin film filter.

The bulk optics method may have a low insertion loss and a large alignment margin. However, when the number of light signals targeted for multiplexing increases, a length of a light path of a light signal may increase rapidly. In addition, the light path may be fixed, and thus a start point of the light signal may need to be accurately controlled because the accurate control of the start point may affect a yield of the light signal multiplexer.

### SUMMARY

An aspect provides a light signal multiplexer and a light signal demultiplexer that may individually set light paths to reduce a length of the light paths despite an increase in the number of light signals, and thus may have a lower insertion loss.

According to an aspect, there is provided a light signal multiplexer including a reflector and a filter. The reflector may be disposed on a plurality of input light paths to allow a plurality of light signals input along the plurality of input light paths to be reflected toward the filter disposed on at least one output light path. The filter may be disposed to allow the light signals reflected toward the filter to be reflected along the at least one output light path. The at least one output light path may correspond to at least one of the plurality of input light paths.

The reflector may be parallel to the filter corresponding to the reflector.

A length from the plurality of input light paths to the at least one output light path may be determined based on at least one of a distance between the reflector and the filter and an angle between the reflector and the plurality of input light paths.

The plurality of light signals may have different wavelengths.

According to another aspect, there is provided a light signal multiplexer including reflector and a filter. The reflector may be disposed on a plurality of input light paths to allow a plurality of light signals input along the plurality of input light paths to be reflected toward the filter disposed on at least one output light path. The filter may be disposed to allow the light signals reflected toward the filter to be reflected along the at least one output light path. The at least one output light path may not correspond to the plurality of input light paths.

The reflector may be parallel to the filter corresponding to the reflector.

A length from the plurality of input light paths to the at least one output light path may be determined based on at least one of a distance between the reflector and the filter and an angle between the reflector and the plurality of input light paths.

The plurality of light signals may have different wavelengths.

According to still another aspect, there is provided a light signal demultiplexer including a reflector and a filter. The filter may be disposed on at least one input light path to allow at least one light signal input along the at least one input light path to be reflected toward the reflector disposed on a plurality of output light paths. The reflector may be disposed to allow the light signal reflected toward the reflector to be reflected along the plurality of output light paths. At least one of the plurality of output light paths may correspond to the at least one input light path.

The reflector may be parallel to the filter corresponding to the reflector.

A length from the at least one input light path to the plurality of output light paths may be determined based on at least one of a distance between the reflector and the filter and an angle between the reflector and the plurality of output light paths.

Light signals to be output along the plurality of output light paths may have different wavelengths.

According to yet another aspect, there is provided a light signal demultiplexer including a reflector and a filter. The filter may be disposed on at least one input light path to allow at least one light signal input along the at least one input light path to be reflected toward the reflector disposed on a plurality of output light paths. The reflector may be disposed to allow the light signal reflected toward the reflector to be reflected along the plurality of output light paths. At least one of the plurality of output light paths may not correspond to the at least one input light path.

The reflector may be parallel to the filter corresponding to the reflector.

A length from the at least one input light path to the plurality of output light paths may be determined based on at least one of a distance between the reflector and the filter and an angle between the reflector and the plurality of output light paths.

Light signals to be output along the plurality of output light paths may have different wavelengths.

According to example embodiments, the light signal multiplexer and the light signal demultiplexer described herein may individually set light paths to reduce a length of the light paths and also have a lower insertion loss, despite an increase in the number of light signals.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the present disclosure will become apparent and more readily appreciated from the following description of example embodiments, taken in conjunction with the accompanying drawings of which:

FIG. 1 is a diagram illustrating a structure of a light signal multiplexer according to an example embodiment;

FIG. 2 is a diagram illustrating a structure of a light signal multiplexer in which an output light path of the light signal multiplexer corresponds to at least one of a plurality of input light paths according to an example embodiment;

FIG. 3 is a diagram illustrating a structure of a reflector and a structure of a filter of a light signal multiplexer according to an example embodiment;

FIG. 4 is a diagram illustrating a structure of a light signal multiplexer in which a light path adjuster is disposed on each of a plurality of input light paths according to an example embodiment;

FIGS. 5A and 5B are diagrams illustrating a structure of a light signal multiplexer in which an output light path does not correspond to an input light path according to an example embodiment;

FIG. 6 is a diagram illustrating a structure of a light signal demultiplexer according to an example embodiment; and

FIG. 7 is a diagram illustrating a structure of a light signal demultiplexer in which an output light path does not correspond to an input light path according to an example embodiment.

### DETAILED DESCRIPTION

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

Various alterations and modifications may be made to the examples. Here, the examples are not construed as limited to the disclosure and should be understood to include all changes, equivalents, and replacements within the idea and the technical scope of the disclosure.

Terms such as first, second, A, B, (a), (b), and the like may be used herein to describe components. Each of these terminologies is not used to define an essence, order or sequence of a corresponding component but used merely to distinguish the corresponding component from other component(s). For example, a first component may be referred to a second component, and similarly the second component may also be referred to as the first component.

It should be noted that if it is described in the specification that one component is “connected,” “coupled,” or “joined” to another component, a third component may be “connected,” “coupled,” and “joined” between the first and second components, although the first component may be directly connected, coupled or joined to the second component. In addition, it should be noted that if it is described in the specification that one component is “directly connected” or “directly joined” to another component, a third component may not be present therebetween. Likewise, expressions, for example, “between” and “immediately between” and “adjacent to” and “immediately adjacent to” may also be construed as described in the foregoing.

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, examples are described in detail with reference to the accompanying drawings. Like reference numerals in the drawings denote like elements, and a known function or configuration will be omitted herein.

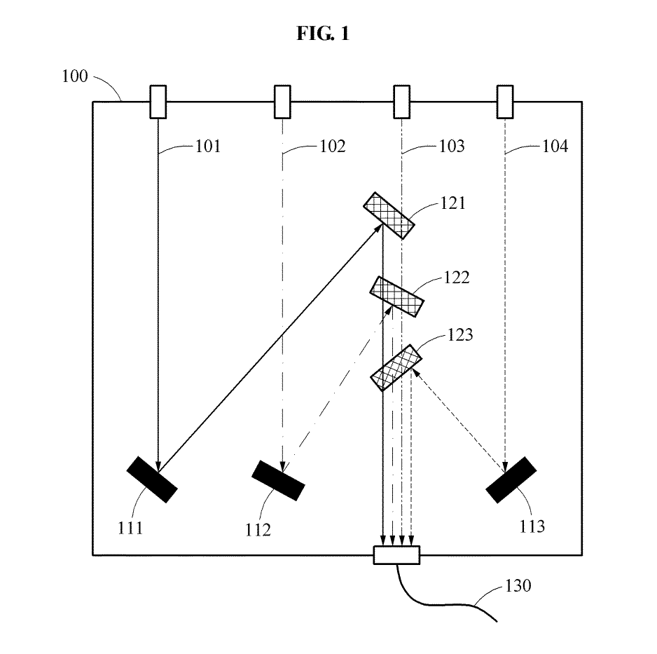

FIG. 1 is a diagram illustrating a structure of a light signal multiplexer 100 according to an example embodiment.

Referring to FIG. 1, a plurality of input light paths includes a first input light path 101, a second input light path 102, a third input light path 103, and a fourth input light path 104. A plurality of light signals input to the light signal multiplexer 100 may proceed along different input light paths. The light signals input to the light signal multiplexer 100 may have different wavelengths.

The light signal multiplexer 100 may set, to be an output light path, at least one among the input light paths 101, 102, 103, and 104. The light signal multiplexer 100 may output a multiplexed light signal through the third input light path 103. Although the light signal multiplexer 100 illustrated in FIG. 1 sets only the third input light path 103 to be the output light path, the light signal multiplexer 100 may have two or more output light paths. That is, at least one output light path of the light signal multiplexer 100 may correspond to at least one among the input light paths.

Referring to FIG. 1, the light signal multiplexer 100 includes a plurality of reflectors, which are illustrated as black boxes, for example, a first reflector 111, a second reflector 112, and a third reflector 113. Here, a reflector may be disposed on an input light path. In addition, the light signal multiplexer 100 also includes a plurality of filters, which are illustrated as latticed boxes, for example, a first filter 121, a second filter 122, and a third filter 123 that correspond to the reflectors 111, 112, and 113, respectively. In the drawings provided hereinafter, a black box indicates a reflector, and a latticed box indicates a filter.

Here, a filter may be disposed on an output light path. A reflector may be disposed to allow a light signal that is input along an input light path to be reflected toward a filter corresponding to the reflector, and the filter may be disposed to allow the light signal that is reflected toward the filter to be reflected along the output light path.

As illustrated in FIG. 1, a first light signal that is input along the first input light path 101 may reach the first reflector 111. The first reflector 111 may be disposed on the first input light path 101, and disposed to allow the first light signal to be reflected toward the first filter 121 corresponding to the first reflector 111. The first reflector 111 may be inclined at a preset angle against the first input light path 101. Here, a reflector may include a material that may reflect a light signal.

The first light signal may proceed to the first filter 121 by the first reflector 111. Here, a filter may be a thin film filter, and may reflect a light signal reaching the filter or pass the light signal to pass through based on a wavelength.

For example, the first filter 121 may reflect only a light signal having the same wavelength as the first light signal, and allow a light signal having a wavelength different from the wavelength of the first light signal to pass through. The first filter 121 may reflect the first light signal along the output light path. Although the first filter 121 is disposed on the third input light path 103, the third input light path 103 may not be affected by the first filter 121 because a light signal that is input along the third input light path 103 has a wavelength different from the wavelength of the first light signal.

The first filter 121 may be disposed to allow the first light signal to be reflected along the output light path. Thus, the first filter 121 may be inclined at a preset angle against the output light path. Although the disposition of the first reflector 111 and the first filter 121 is described herein, the second reflector 112 and the third reflector 113, and the second filter 122 and the third filter 123 may be also disposed in a similar way of the first reflector 111 and the first filter 121 being disposed. Thus, a plurality of light signals that are input along the first input light path 101 through the fourth input light path 104 may be multiplexed onto the single output light path.

As illustrated in FIG. 1, the light signal multiplexer 100 may multiplex four light signals. Each of the light signals may be four 25 gigabits per second (Gbps) light signals having different wavelengths in accordance with a 100GBASE-LR4 standard. The multiplexed light signals may proceed along the output light path, and be output through a single mode optical fiber 130. Although an example of multiplexing four light signals is described with reference to FIG. 1, the light signal multiplexer 100 may multiplex two or three light signals, and also five or more light signals.

According to an example embodiment, the light signal multiplexer 100 may set light paths, independently, each of the light paths using a separate reflector and filter. When the light paths are independently set, a length of each light path may not increase despite an increase in the number of light signals to be multiplexed. Thus, an insertion loss of a light signal may be reduced. Further, the light signal multiplexer 100 may be more readily manufactured because a start point of a light signal does not need to be precisely controlled.

According to an example embodiment, the light signal multiplexer 100 may set two or more output light paths. For example, the light signal multiplexer 100 may set the second input light path 102 to be the output light path, in addition to the third input light path 103. In such an example, light signals that are input along the second input light path 102 and the third input light path 103 may not need an additional reflector or filter, and thus only a reflector and filter for light signals that are input along the first input light path 101 and the fourth input light path 104 may be disposed.

Although the third input light path 103 is set to be the output light path in FIG. 1, the light signal multiplexer 100 may set another input light path to be the output light path.

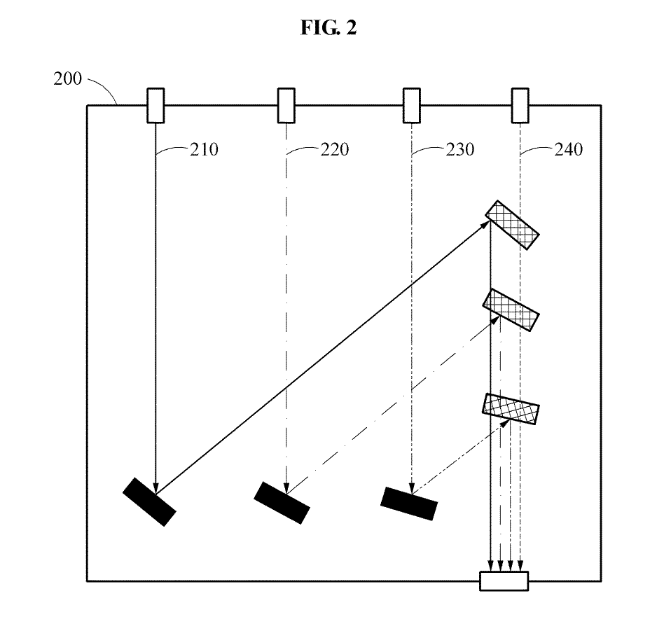

FIG. 2 is a diagram illustrating a structure of a light signal multiplexer 200 in which an output light path of the light signal multiplexer 200 corresponds to at least one of a plurality of input light paths according to an example embodiment. Referring to FIG. 2, the light signal multiplexer 200 may set, to be an output light path, a fourth input light path 240 disposed at a rightmost side among a plurality of input light paths, for example, a first input light path 210, a second input light path 220, a third input light path 230, and the fourth input light path 240.

The output light path of the light signal multiplexer 200 may be flexibly set based on a characteristic of each of the input light paths 210, 220, 230, and 240. The light signal multiplexer 200 may set the fourth input light path 240 to be the output light path because a light signal that is input along the fourth input light path 240 may be more rapidly attenuated compared to other light signals that are input along the other input light paths 210, 220, and 230.

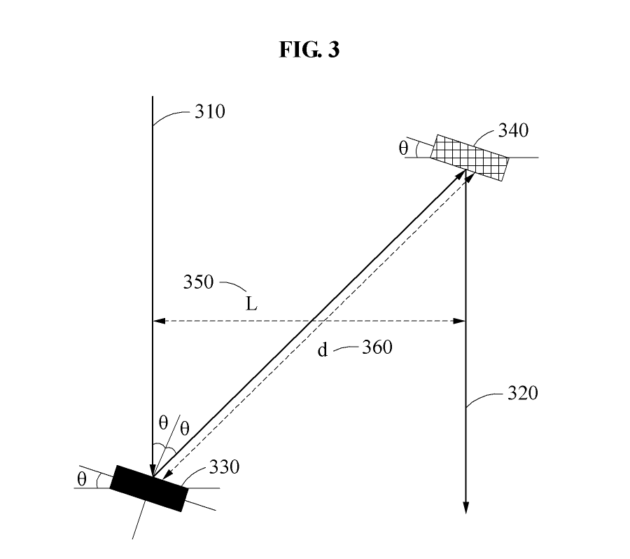

FIG. 3 is a diagram illustrating a structure of a reflector 330 and a structure of a filter 340 of a light signal multiplexer according to an example embodiment.

Referring to FIG. 3, the light signal multiplexer includes the reflector 330 and the filter 340 corresponding to the reflector 330. The reflector 330 may be disposed on an input light path 310, and the filter 340 may be disposed on an output light path 320.

The reflector 330 may be disposed to allow a light signal that is input along the input light path 310 to be reflected toward the filter 340. The filter 340 may be disposed to allow the light signal that is reflected toward the filter 340 to be reflected along the output light path 320. Thus, when the input light path 310 and the output light path 320 are parallel to each other, the reflector 330 and the filter 340 may also be parallel to each other.

As illustrated in FIG. 3, an angle formed between the filter 340 and the output light path 320 may correspond to an angle Θ formed between the reflector 330 and the input light path 310. In such a case, the reflector 330 and the filter 340 may reflect the light signal at a reflection angle identical to an incident angle. An angle to be formed between the input light path 310 and a light path reflected from the reflector 330 may be a double of the angle Θ, for example, 2×Θ. Using a trigonometric function, a relationship between a length L 350 from the input light path 310 to the output light path 320 and a distance d 360 between the reflector 330 and the filter 340 may be derived as represented by Equation 1 below.

L=d×sin(2 Θ) [Equation 1]

Based on Equation 1, the light signal multiplexer may accurately dispose the reflector 330 and the filter 340 that are disposed on a plurality of light paths. Further, the plurality of light paths may be set independently from one another, and thus the light signal multiplexer may be more readily manufactured.

According to an example embodiment, using such a relationship between the reflector 330 and the filter 340, a light path adjuster including the reflector 330 and the filter 340 as one set may be provided.

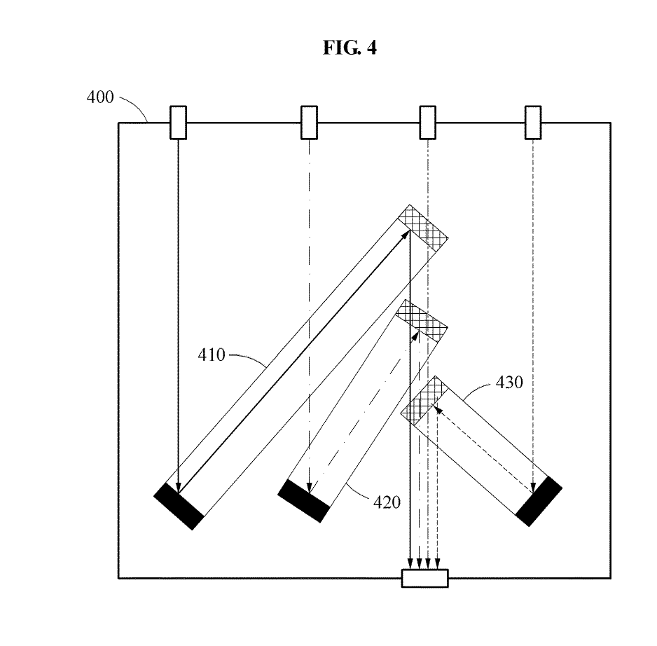

FIG. 4 is a diagram illustrating a structure of a light signal multiplexer 400 in which a light path adjuster is disposed on each of a plurality of input light paths according to an example embodiment.

Referring to FIG. 4, a plurality of light path adjusters, for example, a light path adjuster 410, a light path adjuster 420, and a light path adjuster 430, may include a reflector and a filter. Here, the reflector and the filter may be parallel to each other. Each of the light path adjusters 410, 420, and 430 may be disposed to allow the reflector to be disposed on an input light path, and the filter to be disposed on an output light path. A length of each of the light path adjusters 410, 420, and 430 may be set based on Equation 1.

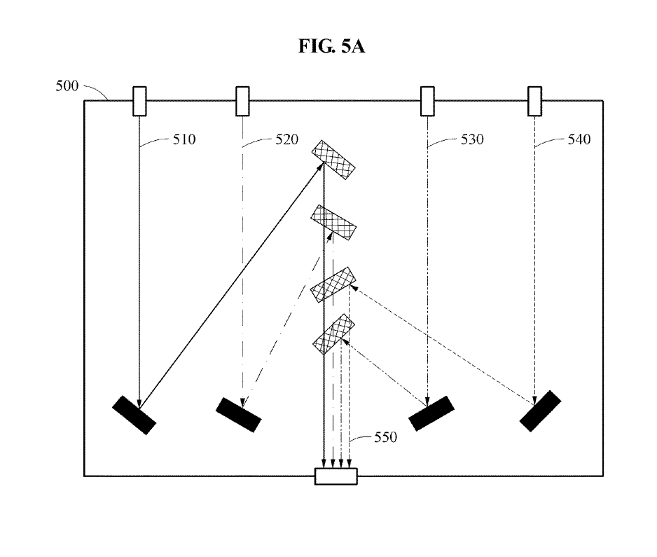

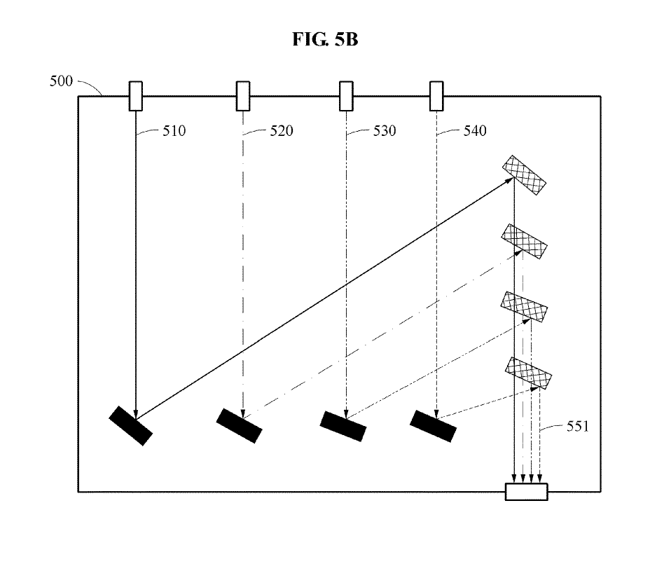

FIGS. 5A and 5B are diagrams illustrating a structure of a light signal multiplexer 500 in which an output light path does not correspond to an input light path according to an example embodiment.

According to an example embodiment, at least one output light path of the light signal multiplexer 500 may not correspond to a plurality of input light paths. The at least one output light path of the light signal multiplexer 500 may be configured independently from the plurality of input light paths. Referring to FIGS. 5A and 5B, an output light path 550 or 551 may not correspond to a first input light path 510, a second input light path 520, a third input light path 530, or a fourth input light path 540.

Referring to FIG. 5A, the output light path 550 may be set to be in the middle of the first input light path 510, the second input light path 520, the third input light path 530, and the fourth input light path 540. Thus, a deviation in lengths of the input light paths 510, 520, 530, and 540 of the light signal multiplexer 500 may be minimized.

Also, the output light path 550 may be set in another space among the input light paths 510, 520, 530, and 540, instead of being in the middle of the input light paths 510, 520, 530, and 540. For example, the output light path 550 may be set in a space between the first input light path 510 and the second input light path 520, or in a space between the third input light path 530 and the fourth input light path 540.

Alternatively, the output light path 550 may be set in another space that is not among the input light paths 510, 520, 530, and 540. For example, referring to FIG. 5B, the output light path 551 may be set outside the input light paths 510, 520, 530, and 540. Thus, an output light path may be set at various locations, and the light signal multiplexer 500 may be more unrestrictedly designed.

According to an example embodiment, in addition to a light signal multiplexer that may individually set and adjust light paths for light signals having different wavelengths, a light signal demultiplexer that may individually set and adjust light paths for light signals having different wavelengths may be provided.

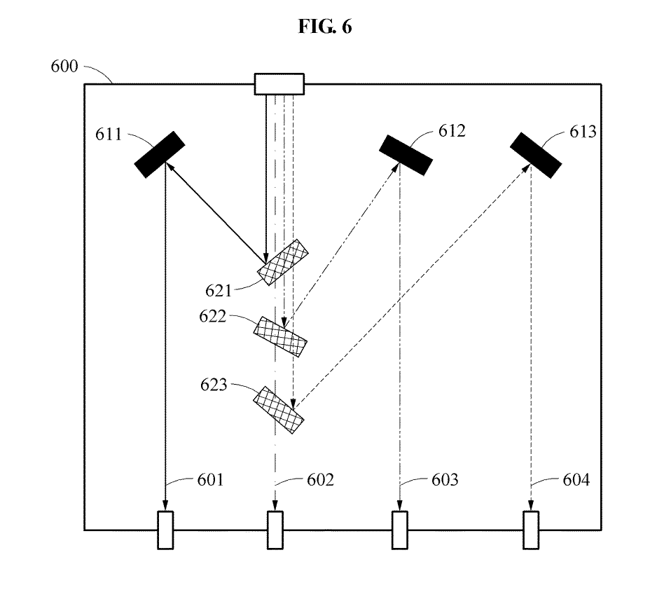

FIG. 6 is a diagram illustrating a structure of a light signal demultiplexer 600 according to an example embodiment.

Referring to FIG. 6, a plurality of output light paths includes a first output light path 601, a second output light path 602, a third output light path 603, and a fourth output light path 604. At least one light signal that is input to the light signal demultiplexer 600 may be demultiplexed along the different output light paths 601, 602, 603, and 604. The light signal input to the light signal demultiplexer 600 may be a multiplexed light signal including a plurality of light signals having different wavelengths.

The light signal demultiplexer 600 may set, to be an input light path, at least one of the output light paths 601, 602, 603, and 604. As illustrated in FIG. 6, the input light path may correspond to the second output light path 602. Although the light signal demultiplexer 600 sets one of the output light paths 601, 602, 603, and 604 to be the input light path in FIG. 6, the light signal demultiplexer 600 may have at least one input light path. That is, the at least one input light path of the light signal demultiplexer 600 may correspond to at least one of a plurality of output light paths.

As illustrated in FIG. 6, the light signal demultiplexer 600 includes a plurality of reflectors, for example, a first reflector 611, a second reflector 612, and a third reflector 613. Here, a reflector may be disposed on an output light path. The light signal demultiplexer 600 also includes a plurality of filters, for example a first filter 621, a second filter 622, and a third filter 623. Here, a filter may be disposed on an input light path, and disposed to allow a light signal that is input along an input light path to be reflected toward a corresponding reflector. The reflector may be disposed to allow the light signal that is reflected toward the reflector to be reflected along an output light path.

In detail, a first light signal that is input along the second output light path 602, which is set to be the input light path, may reach the first filter 621. The first filter 621 may be disposed on the input light path, and disposed to allow the first light signal to be reflected toward the first reflector 611 corresponding to the first filter 621. Thus, the first filter 621 may be inclined at a preset angle against the second output light path 602.

Here, a filter may be a thin film filter. In addition, the filter may reflect a light signal reaching the filter or allow the light signal to pass through based on a wavelength. For example, the first filter 621 may reflect only a light signal having a wavelength identical to a wavelength of the first light signal, and allow a light signal having a wavelength different from the wavelength of the first light signal to pass through. The first filter 621 may reflect the first light signal toward the first reflector 611. In addition, the first filter 621 may allow the light signal having the different wavelength to pass through, excluding the first light signal.

Thus, each of the filters 621, 622, and 623 that are disposed in order on the input light path may reflect only a light signal having a wavelength corresponding to each of the filters 621, 622, and 623 toward a corresponding reflector. That is, each of the filters 621, 622, and 623 may extract only a light signal having a wavelength corresponding to each of the filters 621, 622, and 623. Thus, a multiplexed light signal including a plurality of light signals having different wavelengths may be demultiplexed.

The first light signal may proceed to the first reflector 611 by the first filter 621. Here, a reflector may include a material that may reflect a light signal. The first reflector 611 may be disposed to allow the first light signal to be reflected along the first output light path 601. Thus, the first reflector 611 may be inclined at a preset angle against the first output light path 601.

Although the disposition of the first reflector 611 and the first filter 621 is described herein, the second reflector 612 and the third reflector 613, and the second filter 622 and the third filter 623 may be also disposed in a similar way of the first reflector 611 and the first filter 621 being disposed. A distance between each reflector and a corresponding filter and the preset angle may be determined based on Equation 1.

The light signal demultiplexer 600 may include a plurality of light path adjusters including a reflector and a filter corresponding to the reflector. For example, the light signal demultiplexer 600 may include a first light path adjuster including the first reflector 611 and the first filter 621 corresponding to the first reflector 611, a second light path adjuster including the second reflector 612 and the second filter 622 corresponding to the second reflector 612, and a third light path adjuster including the third reflector 613 and the third filter 623 corresponding to the third reflector 613. A length of each light path adjuster and an angle formed between each light path adjuster and the input light path may be determined based on Equation 1.

Referring to FIG. 6, the light signal demultiplexer 600 may demultiplex a light signal having four different wavelengths that proceeds along one light path. Each light signal may be four 25 Gbps light signals having the different wavelengths in accordance with a 100GBASE-LR4 standard. Although an example of the light signal demultiplexer 600 configured to demultiplex four light signals is described with reference to FIG. 6, the light signal demultiplexer 600 may demultiplex two or three light signals, and also five or more light signals.

According to an example embodiment, the light signal demultiplexer 600 may set light paths independently, each using a separate reflector and filter. When the light paths are set independently from one another, a length of each light path may not increase despite an increase in the number of light signals to be demultiplexed. Thus, an insertion loss of a light signal may be reduced. Further, the light signal demultiplexer 600 may be more readily manufactured because a start point of a light signal does not need to be precisely controlled.

According to an example embodiment, the light signal demultiplexer 600 may demultiplex a light signal that is input along two or more input light paths. For example, the light signal demultiplexer 600 may set the fourth output light path 604 to be the input light path, in addition to the second output light path 602. In such an example, light signals that are output along the second output light path 602 and the fourth output light path 604 may not need an additional reflector and filter, and thus only a reflector and filter for light signals that are output along the first output light path 601 and the third output light path 603 may be disposed.

Although the second output light path 602 is set to be the input light path in FIG. 6, the light signal demultiplexer 600 may set another output light path to be the input light path. In addition, an input light path and an output light path of the light signal demultiplexer 600 may not correspond to each other.

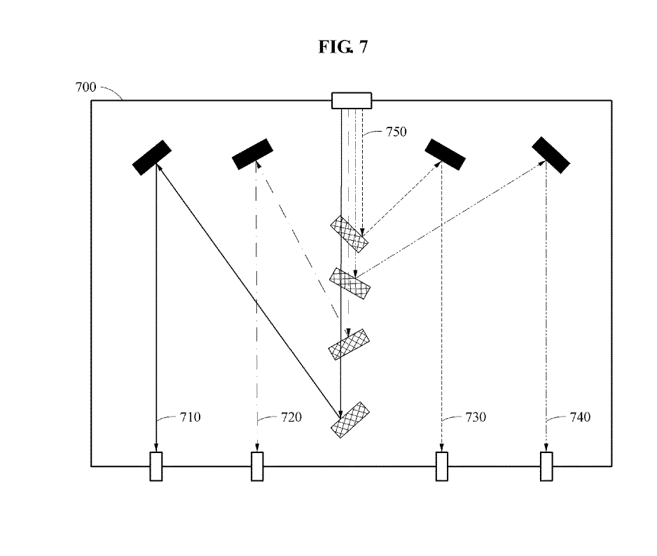

FIG. 7 is a diagram illustrating a structure of a light signal demultiplexer 700 in which an output light path does not correspond to an input light path according to an example embodiment.

A plurality of output light paths of the light signal demultiplexer 700 may not correspond to at least one input light path. The output light paths of the light signal demultiplexer 700 may be configured independently from the input light path. Referring to FIG. 7, an input light path 750 may not correspond to a first output light path 710, a second output light path 720, a third output light path 730, or a fourth output light path 740.

The input light path 750 may be set to be in a space present among the first output light path 710, the second output light path 720, the third output light path 730, and the fourth output light path 740. For example, the input light path 750 may be set to be in the middle of the first output light path 710, the second output light path 720, the third output light path 730, and the fourth output light path 740. Thus, a deviation in lengths of the output light paths 710, 720, 730, and 740 of the light signal demultiplexer 700 may be minimized.

Alternatively, the input light path 750 may be set to be in another space that is not present among the output light paths 710, 720, 730, and 740. For example, the input light path 750 may be set in a left side from the first output light path 710 or in a right side from the fourth output light path 740. Thus, respective locations of an input light path and an output light path may be set independently from one other, and thus the light signal demultiplexer 700 may be more unrestrictedly designed.

The units described herein may be implemented using hardware components and software components. For example, the hardware components may include microphones, amplifiers, band-pass filters, audio to digital convertors, non-transitory computer memory and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A light signal multiplexer comprising:
a reflector; and
a filter,
wherein the reflector is disposed on a plurality of input light paths to allow a plurality of light signals input along the plurality of input light paths to be reflected toward the filter disposed on at least one output light path, and
the filter is disposed to allow the light signals reflected toward the filter to be reflected along the at least one output light path,
wherein the at least one output light path corresponds to at least one of the plurality of input light paths.

2. The light signal multiplexer of claim 1, wherein the reflector is parallel to the filter corresponding to the reflector.

3. The light signal multiplexer of claim 1, wherein a length from the plurality of input light paths to the at least one output light path is determined based on at least one of a distance between the reflector and the filter and an angle between the reflector and the plurality of input light paths.

4. The light signal multiplexer of claim 1, wherein the plurality of light signals have different wavelengths.

5. A light signal multiplexer comprising:
a reflector; and
a filter,
wherein the reflector is disposed on a plurality of input light paths to allow a plurality of light signals input along the plurality of input light paths to be reflected toward the filter disposed on at least one output light path, and
the filter is disposed to allow the light signals reflected toward the filter to be reflected along the at least one output light path,
wherein the at least one output light path does not correspond to the plurality of input light paths.

6. The light signal multiplexer of claim 5, wherein the reflector is parallel to the filter corresponding to the reflector.

7. The light signal multiplexer of claim 5, wherein a length from the plurality of input light paths to the at least one output light path is determined based on at least one of a distance between the reflector and the filter and an angle between the reflector and the plurality of input light paths.

8. The light signal multiplexer of claim 5, wherein the plurality of light signals have different wavelengths.

9. A light signal demultiplexer comprising:
a reflector; and
a filter,
wherein the filter is disposed on at least one input light path to allow at least one light signal input along the at least one input light path to be reflected toward the reflector disposed on a plurality of output light paths, and
the reflector is disposed to allow the light signal reflected toward the reflector to be reflected along the plurality of output light paths,
wherein at least one of the plurality of output light paths corresponds to the at least one input light path.

10. The light signal demultiplexer of claim 9, wherein the reflector is parallel to the filter corresponding to the reflector.

11. The light signal demultiplexer of claim 9, wherein a length from the at least one input light path to the plurality of output light paths is determined based on at least one of a distance between the reflector and the filter and an angle between the reflector and the plurality of output light paths.

12. The light signal demultiplexer of claim 9, wherein light signals to be output along the plurality of output light paths have different wavelengths.
